(19) United States
(12) Patent Application Publication
(10) Pub. No.: US 2004/0188250 A1
(43) Pub. Date: Sep. 30, 2004

(54) Gas concentration detecting apparatus

(75) Inventors: Hiroyuki Sakai, Okazaki-shi (JP); Yoshikazu Hatada, Chiryu-shi (JP); Takashi Kojima, Kasugai-shi (JP)

Correspondence Address: NIXON & VANDERHYE, PC, 1100 N GLEBE ROAD, 8TH FLOOR, ARLINGTON, VA, 22201-4714, US

(73) Assignee: DENSO CORPORATION, Aichi-pref. (JP)

(21) Appl. No.: 10/805,296

(22) Filed: Mar. 22, 2004

(30) Foreign Application Priority Data
Mar. 24, 2003 (JP) 2003-81490

(51) Int. Cl. G01N 27/26

(52) U.S. Cl. 204/412; 204/431

(57) ABSTRACT

A gas concentration sensor includes a sensor element consisting of a pump cell, a monitor cell, and a sensor cell. These cells are heated by a heater and maintained in an activated condition. A sensor control unit measures a weak element current flowing in a sensor element in accordance with the concentration of a specific gas component and intermittently supplies electric power to the heater. The sensor control unit is electrically connected via electric cables to the gas concentration sensor. The weak element current cables and the heater cable are banded together. The electric cables have a shielding layer that is provided outside a core wire through which the element current flows and is fixed to the ground potential.

### BACKGROUND OF THE INVENTION

The present invention relates to a gas concentration detecting apparatus that detects the gas concentration of a specific component contained in a sensing objective gas.

This kind of gas concentration detecting apparatus, for example, incorporates a limit-current type gas concentration sensor that detects NOx (nitrogen oxides) contained in an exhaust gas discharged from an automotive vehicle engine. The gas concentration sensor, for example, has a sensor element consisting of a pump cell, a sensor cell, and a monitor cell. The pump cell has a function of discharging or pumping oxygen out of or into the exhaust gas in a chamber and also detecting the oxygen concentration in the exhaust gas. Furthermore, the sensor cell has a function of detecting the NOx concentration (i.e. the concentration of a specific gas component) in the exhaust gas having passed the pump cell. The monitor cell has a function of detecting the residual oxygen concentration in the chamber after the exhaust gas has passed the pump cell.

The above-described gas concentration sensor can perform an ordinary operation for detecting the oxygen concentration or the NOx concentration only when the sensor element is maintained at a predetermined activated condition. To this end, a heater is generally provided in the vicinity of the sensor element to heat the sensor element and maintain the sensor element at the activated condition. For example, based on a monitored resistance value of the sensor element, the electric power to the heater is intermittently supplied in such a manner that the element resistance value is equalized to a target value corresponding to the activated temperature (refer to the Japanese Patent Application Laid-open No. 2000-171435).

More specifically, according to a NOx sensor serving as one of the gas concentration sensors, NOx contained in the exhaust gas decomposes on a NOx active electrode of its sensor cell. In this case, oxygen ions flow in the sensor cell. Measuring the current flowing in the sensor cell in this moment enables to detect the NOx concentration. The sensor cell current is a weak current of nA (nanoampere) order. To measure this weak current, a sensor control circuit has a current detection resistor having a higher resistance value (e.g. 1.5 MΩ). On the other hand, the electric power supply to the heater is intermittently carried out by a heater actuating circuit. In this case, the heater current of A (ampere) order is ON/OFF controlled.

In general, the sensor control circuit and the heater actuating circuit are mounted on the same circuit substrate, and this circuit substrate is accommodated in a metallic casing or the like to constitute a sensor control unit. The sensor control unit and the gas concentration sensor are electrically connected via a wiring unit. In other words, the wiring unit allows the sensor cell current or other element current signal and the heater current signal to flow or propagate between the sensor control unit and the gas concentration sensor. The electric cable constituting this wiring unit includes a sheathing member made of a resin material or the like having sufficient heat resistance. The sheathing member is, for example, a glass braided silicone member, silicone organized EPDM rubber, nylon, polyamide or other resin materials.

The wiring unit has a function of electrically connecting the sensor control unit and the gas concentration sensor. Accordingly, the wiring unit includes an electric cable used for measuring the weak element current of nA order as well as an electric cable used for supplying the heater current of A (ampere) order which are usually banded together in the wiring unit. In this case, when simply compared with respect to the current level, the heater current is 10⁹ times larger than the element current. Thus, the element current cable is possibly bothered with the noise (e.g. induction noise and capacity coupling noise) added when the power supply to the heater is ON/OFF switched. The detection accuracy required for the NOx concentration cannot be assured. These problems can be confirmed in radio wave tests (e.g. EMC tests). Furthermore, recent automotive vehicles are equipped with various electric devices that become noise sources adversely influencing the element current signals.

### SUMMARY OF THE INVENTION

In view of the above-described problems, the present invention has an object to provide a gas concentration detecting apparatus that is capable of accurately detecting the element current and is further capable of improving the detection accuracy for the gas concentration.

In order to accomplish the above and other related objects, the gas concentration detecting apparatus of the present invention includes a gas concentration sensor equipped with a sensor element having a solid electrolytic substrate for detecting a gas concentration of a specific component contained in a sensing objective gas and a heater for heating the sensor element to a predetermined activated condition. A sensor control unit is provided for measuring a weak element current flowing in the sensor element in accordance with the concentration of the specific component and for intermittently supplying electric power to the heater. And, a wiring unit is provided for providing electric connection between the gas concentration sensor and the sensor control unit.

More specifically, according to the gas concentration detecting apparatus of the present invention, the wiring unit includes an element current cable used for measuring the element current and a heater cable used for supplying electric power to the heater. And, a shielding layer fixed to a ground potential is provided outside a core wire of the element current cable through which the element current flows.

As the element current flowing in the element current cable is weak, the induction noise or capacity coupling noise of the heater cable gives serious influence to the element current.

Providing the shielding layer surrounding the core wire of the element current cable in the above-described manner is effective in eliminating the adverse influence of these noises. Furthermore, the present invention brings sufficient noise durability even when various electric devices (i.e. noise sources) are equipped in an automotive vehicle. As a result, accurately detecting the element current is feasible. Furthermore, the detection accuracy for the gas concentration can be improved.

According to a preferred embodiment of the present invention, the element current cable includes a sheathing layer surrounding the core wire and the shielding layer covers the outside of the sheathing layer. In the case that the sheathing layer is provided between the core wire and the shielding layer, there is the possibility that the element current may leak via the sheathing layer due to the potential difference between the core wire and the shielding layer. Hence, to eliminate such leakage of the element current, it is preferable that a volume resistivity of the sheathing layer is equal to or larger than 1.0×10¹² (Ω·cm).

To satisfy the above-described characteristics of the sheathing layer, it is preferable that the sheathing layer is made of Teflon (registered trademark). Although the volume resistivity required for the sheathing layer varies depending on the required detection accuracy for the element current or the wiring length or other factors, Teflon (registered trademark) has the volume resistivity equal to or larger than 1.0×10¹⁸ (Ω·cm) and accordingly can sufficiently satisfy the above required volume resistivity for the sheathing layer. Therefore, using the Teflon-made sheathing layer is effective in surely eliminating the leakage of the element current.

According to a preferred embodiment of the present invention, the element current cable includes a plurality of core wires that are collectively covered with the shielding layer. In this case, the arrangement of a plurality of core wires becomes simple and fits to an element current cable. As the current flowing in respective core wires collectively surrounded with the shielding layer is weak, the current generates no noise influencing other wires.

As a practical arrangement for the element current cable, it is preferable that the element current cable includes at least one core wire covered with a sheathing layer and the shielding layer is located outside the sheathing layer, and further a protecting layer is provided outside the shielding layer. Furthermore, it is preferable that the element current cable includes a plurality of core wires each being covered with a sheathing layer and the shielding layer is located outside the plurality of core wires, and further a protecting layer is provided outside the shielding layer.

According to a preferred embodiment of the present invention, the ground processing for fixing the shielding layer of the element current cable to the ground potential is carried out separately from the ground processing for fixing the heater to the ground potential. This effectively prevents the variation of the ground potential (reference potential) occurring in the heater from adversely influencing the ground potential of the shielding layer.

According to a preferred embodiment of the present invention, the wiring unit is connected to the sensor control unit via a connector member, and a shield surrounds the outer surface of the connector member. This brings a desirable arrangement capable of improving the noise durability of the connector member and also improving the detection accuracy for the gas concentration.

According to a preferred embodiment of the present invention, an element current connector used for connecting the element current cable to the sensor control unit is provided separately from a heater connector used for connecting the heater cable to the sensor control unit. This brings a desirable arrangement capable of improving the noise durability of the element current connector and further improving the detection accuracy for the gas concentration. It is also possible to provide a shield surrounding the element current connector so as to further improve the noise durability.

Furthermore, according to a preferred embodiment of the present invention, a control circuit section included in the sensor control unit is accommodated in a closed space of a casing that is made of an electrically-conductive material and fixed to the ground potential, and a feedthrough capacitor is disposed on a wall portion of the casing, and further a connecting circuit section electrically connected to the wiring unit is disposed outside the closed space, and the connecting circuit section and the control circuit section are electrically connected via the feedthrough capacitor. This arrangement enables the feedthrough capacitor to absorb external radio wave noises superposed on the wiring unit. Furthermore, the control circuit section of the sensor control unit is disposed in the closed space separately from the connecting circuit section (i.e. the wiring unit). The control circuit section is free from the external noises that give adverse influences. In this case, the sensor control unit handles a weak element current that represents the concentration of a specific component. The above arrangement is effective in suppressing the adverse influence given from the radio wave noises. As a result, accurately detecting the element current is feasible. And, the detection accuracy for measuring the gas concentration can be improved.

In this respect, the present invention provides another gas concentration detecting apparatus including a gas concentration sensor equipped with a sensor element having a solid electrolytic substrate for detecting a gas concentration of a specific component contained in a sensing objective gas and a heater for heating the sensor element to a predetermined activated condition, a sensor control unit for measuring a weak element current flowing in the sensor element in accordance with the concentration of the specific component and for intermittently supplying electric power to the heater, and a wiring unit for providing electric connection between the gas concentration sensor and the sensor control unit, wherein a control circuit section included in the sensor control unit is accommodated in a closed space of a casing that is made of an electrically-conductive material and fixed to the ground potential, and a feedthrough capacitor is disposed on a wall portion of the casing, and further a connecting circuit section electrically connected to said wiring unit is disposed outside the closed space, and the connecting circuit section and the control circuit section are electrically connected via the feedthrough capacitor.

Furthermore, according to a preferred embodiment of the present invention, a casing made of an electrically-conductive material and fixed to the ground potential is divided into two chambers with a partition plate made of an electrically-conductive material and fixed to the ground potential, a feedthrough capacitor is disposed on the partition plate, a control circuit section included in the sensor control unit and a connecting circuit section electrically connected to the wiring unit are respectively accommodated into these two chambers, and the control circuit section and the connecting circuit section are electrically connected via the feedthrough capacitor.

This arrangement enables the feedthrough capacitor to absorb external radio wave noises superposed on the wiring unit. Furthermore, the control circuit section of the sensor control unit is disposed in another chamber separately from the connecting circuit section. The control circuit section is free from the external noises that give adverse influences. In this case, the sensor control unit handles a weak element current that represents the concentration of a specific component. The above arrangement is effective in suppressing the adverse influence given from the radio wave noises. As a result, accurately detecting the element current is feasible. And, the detection accuracy for measuring the gas concentration can be improved.

In this respect, the present invention provides another gas concentration detecting apparatus including a gas concentration sensor equipped with a sensor element having a solid electrolytic substrate for detecting a gas concentration of a specific component contained in a sensing objective gas and a heater for heating the sensor element to a predetermined activated condition, a sensor control unit for measuring a weak element current flowing in the sensor element in accordance with the concentration of the specific component and for intermittently supplying electric power to the heater, and a wiring unit for providing electric connection between the gas concentration sensor and the sensor control unit, wherein a casing made of an electrically-conductive material and fixed to a ground potential is divided into two chambers with a partition plate made of an electrically-conductive material and fixed to the ground potential, a feedthrough capacitor is disposed on the partition plate, a control circuit section included in the sensor control unit and a connecting circuit section electrically connected to the wiring unit are respectively accommodated into these two chambers, and the control circuit section and the connecting circuit section are electrically connected via the feedthrough capacitor.

Preferably, the control circuit section and the connecting circuit section are provided on the same circuit substrate, and the partition plate is provided on the circuit substrate so that the partition plate extends vertically between the control circuit section and the connecting circuit section. In this case, it is preferable that a surface on which the wiring unit is connected to the circuit substrate is identical with a surface from which the partition plate stands.

Preferably, a capacitance of the feedthrough capacitor is equal to or larger than 1000 pF.

For example, a NOx sensor is used to detect NOx contained in the exhaust gas of an automotive vehicle. The NOx sensor has a pump cell adjusting the oxygen introduced into or discharged from a chamber, and a sensor cell decomposing NOx from the gas having passed the pump cell and detecting the NOx concentration based on an oxygen ion amount moving in accordance with the decomposition of NOx. The current flowing in the sensor cell is a weak current of nA order. The present invention can be preferably applied to this kind of NOx sensor.

More specifically, it is preferable that the sensor element includes a first cell for discharging or pumping oxygen out of or into the sensing objective gas in a chamber, a second cell for decomposing the specific component contained in the gas after the gas passed the first cell and detecting a gas concentration of the specific component based on an oxygen ion amount moving during decomposition of the specific component, and the sensor control unit measures a weak current flowing at least in the second cell.

### BRIEF DESCRIPTION OF THE DRAWINGS

The above and other objects, features and advantages of the present invention will become more apparent from the following detailed description which is to be read in conjunction with the accompanying drawings, in which:

FIG. 1 is a block diagram showing a gas concentration detecting apparatus in accordance with a preferred embodiment of the present invention;

FIG. 2A is a perspective view showing a detailed arrangement of a sensor control unit in accordance with the preferred embodiment of the present invention;

FIG. 2B is a cross-sectional view showing the sensor control unit taken along a line X-X of FIG. 2A;

FIG. 3 is a perspective view showing an arrangement of an electric cable in accordance with the preferred embodiment of the present invention;

FIG. 4 is a perspective view showing an arrangement of another electric cable in accordance with the preferred embodiment of the present invention;

FIGS. 5A to 5C are cross-sectional views showing various examples of the electric cable in accordance with the preferred embodiment of the present invention;

FIG. 6A is a cross-sectional view showing an arrangement of a gas concentration sensor in accordance with the preferred embodiment of the present invention;

FIG. 6B is a cross-sectional view showing the gas concentration sensor taken along a line A-A of FIG. 6A;

FIG. 7 is a view showing an appearance of the gas concentration sensor;

FIG. 8 is a view explaining the volume resistivity;

FIGS. 9A and 9B are views explaining the volume resistivity;

FIG. 10 is a cross-sectional view showing an arrangement of a connector portion equipped with a shield;

FIG. 11A is a perspective view showing a detailed arrangement of a modified sensor control unit in accordance with the preferred embodiment of the present invention; and

FIG. 11B is a cross-sectional view showing the sensor control unit taken along a line X-X of FIG. 11A.

### DESCRIPTION OF THE PREFERRED EMBODIMENTS

Preferred embodiments of the present invention will be explained hereinafter with reference to attached drawings.

A gas concentration detecting apparatus in accordance with this embodiment is, for example, applied to an engine of an automotive vehicle. The gas concentration detecting apparatus incorporates a limit-current type gas concentration sensor capable of detecting the oxygen concentration in an exhaust gas serving as a sensing objective gas or detecting the NOx concentration as the gas concentration of a specific component.

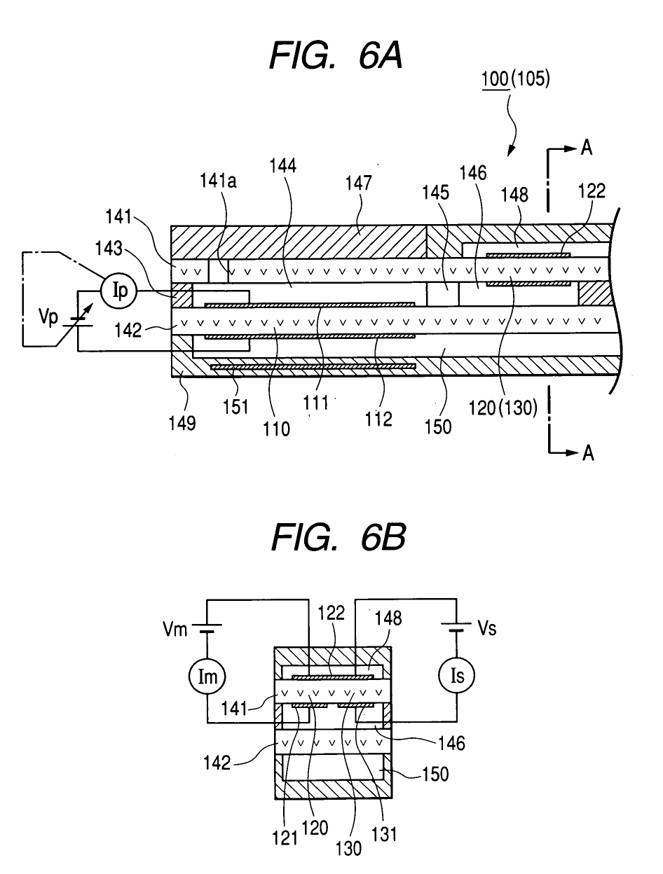

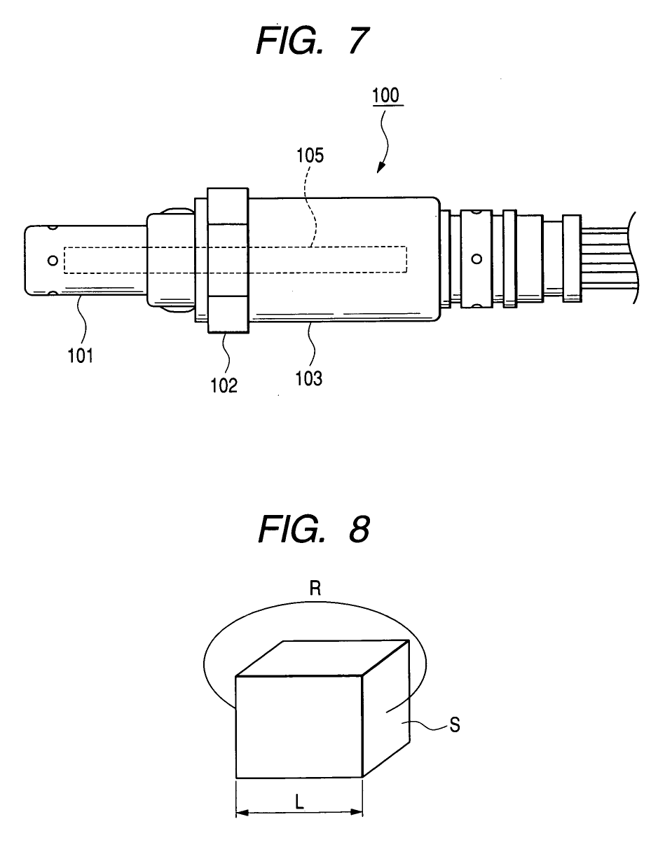

FIGS. 6 and 7 show the arrangement of the gas concentration sensor that includes a pump cell serving as a “first cell”, a sensor cell serving as a “second cell”, and a monitor cell serving as a “third cell” that cooperatively constitute a 3 cell construction. The gas concentration sensor is a so-called combined type gas sensor capable of simultaneously detecting the oxygen concentration and the NOx concentration in the exhaust gas (although it is possible to arrange this sensor as a NOx sensor). This embodiment is based on the sensor element employing the above-described 3 cell arrangement. The monitor cell may be referred to as a second pump cell because it has the capability similar to the pump cell having a function of discharging the oxygen from the gas. FIG. 6A is a cross-sectional view showing the arrangement of a front end of a sensor element. FIG. 6B is a cross-sectional view taken along a line A-A of FIG. 6A. FIG. 7 is a view showing an overall appearance of the gas concentration sensor.

As shown in FIG. 7, the gas concentration sensor 100 includes a distal end cover 101, a housing 102, and a proximal end cover 103 and is configured into a cylindrical shape as a whole. Furthermore, the concentration sensor 100 includes a gas chamber and an air chamber defined in the sensor. A sensing objective gas is introduced into the gas chamber. The air is introduced into the air chamber. A sensor element 105 having an elongated shape is also provided in the sensor.

As shown in FIG. 6, the gas concentration sensor 100 (sensor element 105) has two solid electrolytic substrates 141 and 142 each being made of an oxygen ion conductive material. A spacer 143 being made of alumina or a comparable insulating material intervenes between these solid electrolytic substrates 141 and 142, so that the solid electrolytic substrates 141 and 142 are laminated in the up-and-down direction and spaced from each other with a predetermined gap as shown in the drawing. The upper solid electrolytic substrate 141 has a pinhole 141a through which the exhaust gas existing near the sensor element 105 is introduced into a first chamber 144. The first chamber 144 communicates via an orifice 145 with a second chamber 146. A porous diffusion layer 147 is provided at the outermost side.

The lower solid electrolytic substrate 142 has a pump cell 110 located so as to be directly positioned in the first chamber 144. The pump cell 110 has a function of discharging or pumping the oxygen from or to the exhaust gas introduced into the first chamber 144. Furthermore, the pump cell 110 has a function of detecting the oxygen concentration in the exhaust gas during its oxygen discharging or pumping operation. More specifically, the pump cell 110 has a pair of electrodes 111 and 112 provided on the upper and lower surfaces of the solid electrolytic substrate 142. The upper electrode 111 located in the first chamber 144 is a NOx inactive electrode (i.e. the electrode having no capability of decomposing NOx gas). The pump cell 110 decomposes the oxygen residing in the first chamber 144 and discharges the decomposed oxygen from the electrode 112 to an air passage 150.

Furthermore, the upper solid electrolytic substrate 141 has a monitor cell 120 and a sensor cell 130 located so as to be directly placed in the second chamber 146. The monitor cell 120 generates an electromotive force in accordance with the residual oxygen concentration in the second chamber 146 or current generates a current output in response to an applied voltage. Furthermore, the sensor cell 130 detects the NOx concentration in the gas having passed the pump cell 110.

According to this embodiment, as shown in FIG. 6B, the monitor cell 120 and the sensor cell 130 are disposed in parallel with each other so as to be located at the same position with respect to the flowing direction of the exhaust gas. These cells 120 and 130 have a common electrode 122 located in an air passage 148. Namely, the monitor cell 120 consists of the solid electrolytic substrate 141 and a pair of electrodes (i.e. the electrode 121 and the common electrode 122) disposed on the opposed surfaces of the solid electrolytic substrate 141. The sensor cell 130 consists of the solid electrolytic substrate 141 and a pair of electrodes (i.e. the electrode 131 and the common electrode 122) disposed on the opposed surfaces of the solid electrolytic substrate 141. The electrode 121 (i.e. the electrode located in the second chamber 146) of the monitor cell 120 is made of Au—Pt or other noble metal inactive against NOx gas. On the other hand, the electrode 131 (i.e. the electrode located in the second chamber 146) of the sensor cell 130 is made of platinum (Pt), rhodium (Rh) or other noble metal active against NOx gas.

An insulating layer 149, being made of alumina or the like, is provided under the solid electrolytic substrate 142 in the drawing. The insulating layer 149 and the solid electrolytic substrate 142 cooperatively define the air passage 150. Furthermore, the insulating layer 149 includes a heater (i.e. heat generating element) 151 embedded therein. The heater 151 generates heat for increasing the temperature of the sensor body. Namely, the heater 151 has a function of activating the entire sensor element including the pump cell 110, the monitor cell 120, and the sensor cell 130. The heater 151 receives electric power from an automotive battery to generate heat energy,

According to the above-described gas concentration sensor 100, the exhaust gas is introduced via the porous diffusion layer 147 and the pinhole 141a into the first chamber 144. When the introduced exhaust gas passes the pump cell 110, a voltage Vp is applied between two pump cell electrodes 111 and 112 to cause the decomposing reaction. The oxygen is discharged from or introduced into the first chamber 144 via the pump cell 110 in accordance with the oxygen concentration in the first chamber 144. As the pump cell electrode 111 positioned in the first chamber 144 is the NOx inactive electrode, the NOx in the exhaust gas is not decomposed at the pump cell 110 and accordingly only the oxygen is decomposed and discharged to the air passage 150. The oxygen concentration in the exhaust gas is detected based on the current flowing in the pump cell 110 (i.e. pump cell current Ip).

The exhaust gas having passed the pump cell 110 flows into the second chamber 146. The monitor cell 120 generates an output representing the residual oxygen concentration in the gas. A predetermined voltage Vm is applied between the monitor cell electrodes 121 and 122 to detect the output of the monitor cell 120 as a monitor cell current Im. Furthermore, a predetermined voltage Vs is applied between the sensor cell electrodes 131 and 122 to reduce and decompose the NOx in the gas. The oxygen resulting from the reducing and decomposing reaction is discharged to the air passage 148. In this case, the NOx concentration in the exhaust gas is detected based on the current flowing in the sensor cell 130 (i.e. sensor cell current Is).

The voltage Vp applied to the pump cell 110 is variably controlled in accordance with the momentary oxygen concentration in the exhaust gas (i.e. in accordance with the pump cell current Ip). For example, it is preferable to use a map defining the relationship between an applied voltage and the pump cell current. Such a map can be prepared beforehand based on the limit current characteristics of the pump cell 110. The applied voltage Vp is momentarily controlled in accordance with the measured pump cell current with reference to this map. The voltage control for the pump cell 110 is carried out in such a manner that the applied voltage shifts to a higher voltage side when the oxygen concentration in the exhaust gas becomes high.

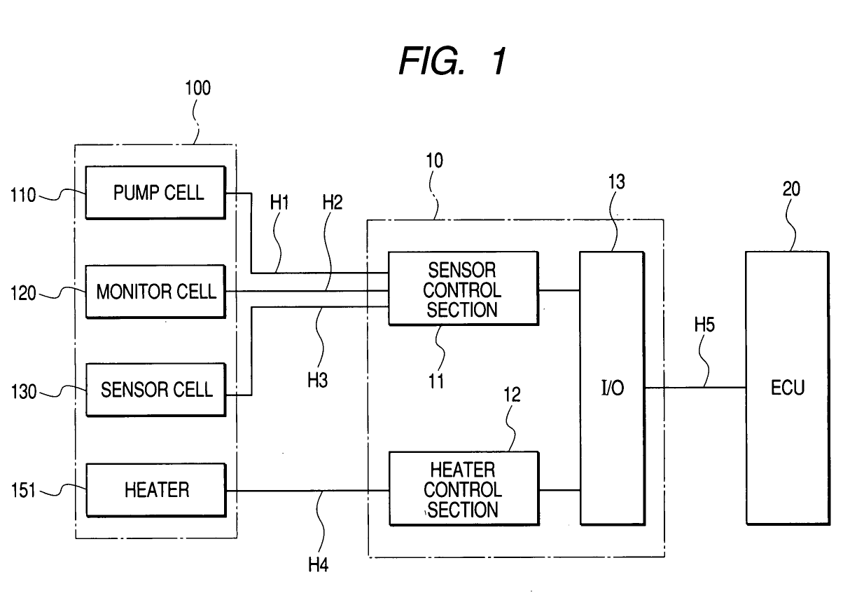

FIG. 1 is a block diagram showing a schematic arrangement of the gas concentration detecting apparatus. In FIG. 1, a sensor control unit 10 includes a sensor control section 11, a heater control section 12, and an input/output section (i.e. I/O port) 13. The sensor control section 11 is electrically connected via electric cables H1, H2, and H3 to the pump cell 110, the monitor cell 120, and the sensor cell 130 having the above-described arrangements. The sensor control section 11 has a function of applying predetermined voltages to respective cells 110 to 130 of the gas concentration sensor 100. The sensor control section 11 has current detection resistors to measure the element currents (i.e. current signals) flowing in respective cells 110 to 130.

In this case, the current signal of mA (milliampere) order flowing in the pump cell 110 is sent via the electric cable H1 to the sensor control section 11 and is measured with the current detection resistor provided in the control section 11. Then, the sensor control section 11 detects the oxygen concentration in the exhaust gas (i.e. A/F) based on the measured pump cell current signal. Furthermore, the current signals of nA (nanoampere) order flowing in the monitor cell 120 and the sensor cell 130 are sent via the electric cables H2 and H3 to the sensor control section 11 and are measured with the current detection resistors provided in the control section 11. Then, the sensor control section 11 detects the residual oxygen concentration in the second chamber 146 based on the measured monitor cell current signal and also detects the NOx concentration based on the sensor cell current signal. The detected values of the oxygen concentration and the NOx concentration are sent via the input/output section 13 and an electric cable H5 to an external engine ECU 20 or the like.

Furthermore, the heater control 12 is electrically connected via an electric cable H4 to the heater 151. The heater control section 12 intermittently supplies electric power to the heater 151. More specifically, the heater control section 12 includes a switching element (e.g. MOSFET) or an actuating driver to execute PWM control for supplying electric power to the heater 151 with reference to a Duty signal produced, for example, from a calculating section such as CPU.

The electric cables Hi to H5 are generally united by means of a tie band such as Tyrap (registered trademark) to simplify the wiring layout. Connector portions are provided at both ends of these cables. The electric cables H1 to H5 and their connector portions cooperatively constitute the wiring unit (although not shown). Furthermore, the electric cables H2 and H3 connected to the monitor cell 120 and the sensor cell 130 are used for measuring the weak element current of nA (nanoampere) level. In this respect, the electric cables H2 and H3 serve as the “element current cable” of the present invention. On the other hand, the electric cable H4 connected to the heater 151 is used for supplying the heater current of A (ampere) level. In this respect, the electric cable H4 serves as the “heater cable” of the present invention.

In the above-described sensor control unit 10, various electric parts and a microcomputer for constituting the sensor control section 11 and the heater control section 12 are mounted on the same sensor control circuit substrate. This circuit substrate is accommodated in a thin rectangular boxlike casing. In this case, the sensor control section 11 includes a circuit arrangement for detecting the weak current of nA (nanoampere) level, and accordingly needs to be protected against external noises. Hereinafter, the characteristic arrangement of the sensor control unit 10 capable of suppressing the influence of noises will be explained.

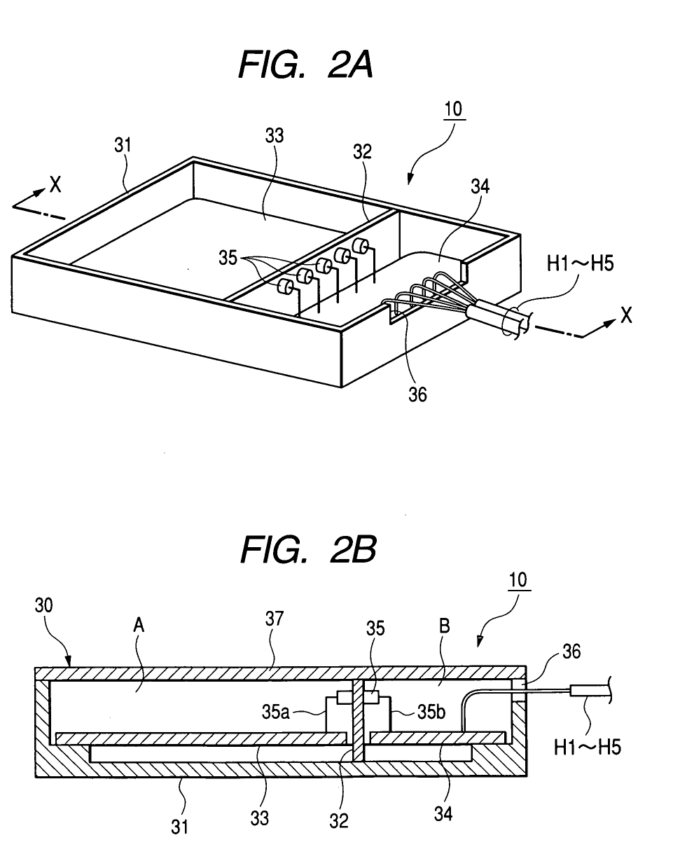

FIG. 2A is a perspective view showing the detailed arrangement of the sensor control unit 10 under a condition that a cover plate 37 is removed from a casing body 31 of the casing 30. FIG. 2B is a cross-sectional view showing the sensor control unit 10 taken along a line X-X of FIG. 2A.

The casing body 31 is made of a metallic member, such as aluminum, or an electrically-conductive material, such as an electrically-conductive plastic, and is configured into a box shape with an opened top. The inside space of the casing is divided into two chambers with a partition plate 32 being made of an electrically-conductive material. The sensor control circuit substrate 33 is accommodated in one chamber, while the wiring connecting substrate 34 is accommodated in the other chamber. The partition plate 32 is brought into contact with the casing body 31. Both of the casing body 31 and the partition plate 32 are fixed to the ground potential. The sensor control circuit substrate 33 serves as the “control circuit section” of the present invention. The wiring connecting substrate 34 serves as the “connecting circuit section” of the present invention. Hereinafter, the chamber accommodating the sensor control circuit substrate 33 is referred to as a first chamber A, while the chamber accommodating the wiring connecting substrate 34 is referred to as a second chamber B.

The partition plate 32 is provided with a plurality of feedthrough capacitors 35 arrayed laterally in a line. An inside terminal of each feedthrough capacitor 35 is connected to the ground via the partition plate 32 and the casing body 31. Lead lines 35a and 35b extending from both ends of each feedthrough capacitor 35 are connected to the sensor control circuit substrate 33 and the wiring connecting substrate 34, respectively. In other words, two substrates 33 and 34 are electrically connected via the feedthrough capacitors 35. Preferably, each feedthrough capacitor 35 has capacitance equal to or larger than 1000 pF. According to this embodiment, the partition plate 32 has a function of supporting a plurality of feedthrough capacitors 35 and a function of grounding their inside terminals in addition to the function of dividing the casing 30 into two chambers.

Although FIG. 2A shows a total of five feedthrough capacitors 35, the total number of actually used feedthrough capacitors 35 should be determined considering the number of connecting terminals provided on the sensor control circuit substrate 33, i.e. the total number of core wires contained in respective electric cables H1 to H5.

Furthermore, the casing body 31 has a wiring inlet opening 36 formed as a rectangular cutout at one side surface. The electric cables H1 to H5 extend into the casing 30 via the wiring inlet opening 36 and are electrically connected to the wiring connecting substrate 34. Then, under the condition that the partition plate 32 and the circuit substrates 33 and 34 are disposed in the casing body 31, the cover plate 37 is attached to the casing body 31 to hermetically close the first chamber A accommodating the sensor control circuit substrate 33.

According to the above-described arrangement of the sensor control unit 10, the first chamber A accommodating the sensor control circuit substrate 33 is substantially isolated from the second chamber B accommodating the wiring connecting substrate 34. The electric potential of the casing 30 is fixed to the ground potential. Accordingly, it is possible to prevent the first chamber A from being adversely influenced by external radio wave noises entering into the second chamber B. Furthermore, the radio wave noises superposed on respective electric cables H1 to H5 can be absorbed by the feedthrough capacitors 35. The above-described arrangement can stabilize the operation of the sensor control circuit substrate 33 and accordingly improve the reliability of this device.

Meanwhile, among a plurality of electric cables H1 to H4 providing electrical connection between the gas concentration sensor 100 and the sensor control unit 10, the electric cables H2 and H3 used for measuring the weak element currents of nA (nanoampere) level tend to be adversely influenced by induction noise or capacity coupling noise generated from adjacent electric cable H4 used for supplying the heater current of A (ampere) level. As a result, the detection accuracy for NOx concentration will deteriorate. Hence, this embodiment employs a shield arrangement capable of protecting the electric cables H2 and H3 from the noises. Regarding the electric cables H1 and H4 each being used for supplying a relatively large current, no shield is necessary and accordingly a resin sheathing arrangement is employable.

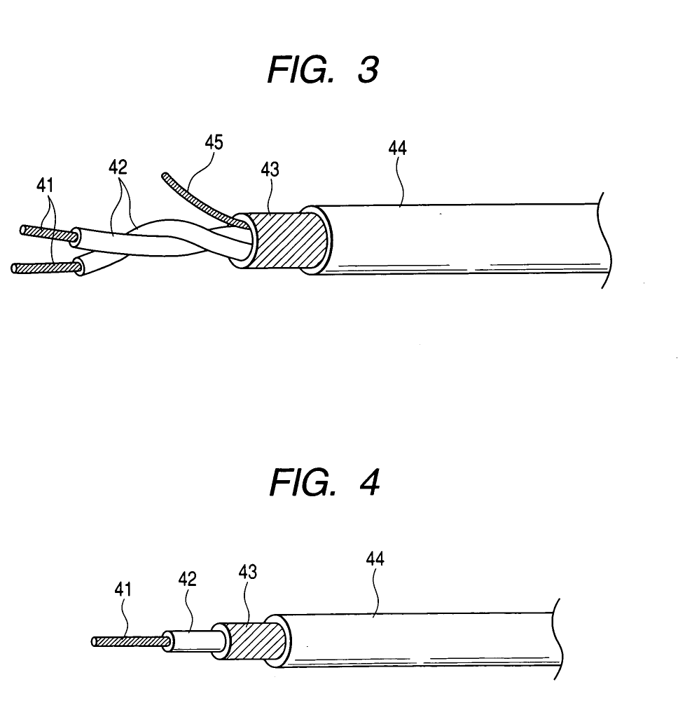

FIG. 3 is a perspective view showing a wiring structure applicable to the electric cables H2 and H3, as a multiple-core structure for collectively covering a plurality of (two in this drawing) core wires with a shielding layer.

According to the arrangement of FIG. 3, each core wire 41 is surrounded by a sheathing layer 42 made of an insulating material and respective core wires 41 are collectively covered by a shielding layer 43 constituting the braided shield. Furthermore, the shielding layer 43 is surrounded by a vinyl sheath 44. The shielding layer 43 is made of a material having higher electric conductivity, such as tin plated soft copper wire, stainless (SUS304) or a comparable material. Preferably, the braid density of the shielding layer 43 is equal to or larger than 90%. It is however possible to use a lateral winding shield or a conductive tape instead of using the braided shield. Any material and structure, when assuring satisfactory shield effect, will be employed. FIG. 3 shows a drain wire 45 that is, for example, connected to the casing 30 of the sensor control unit 10, so that the electric potential of shielding layer 43 is fixed to the ground potential.

FIG. 4 is a perspective view showing another wiring structure applicable to the electric cables H2 and H3, as a single-core structure for covering only one core wire 41 with the shielding layer 43.

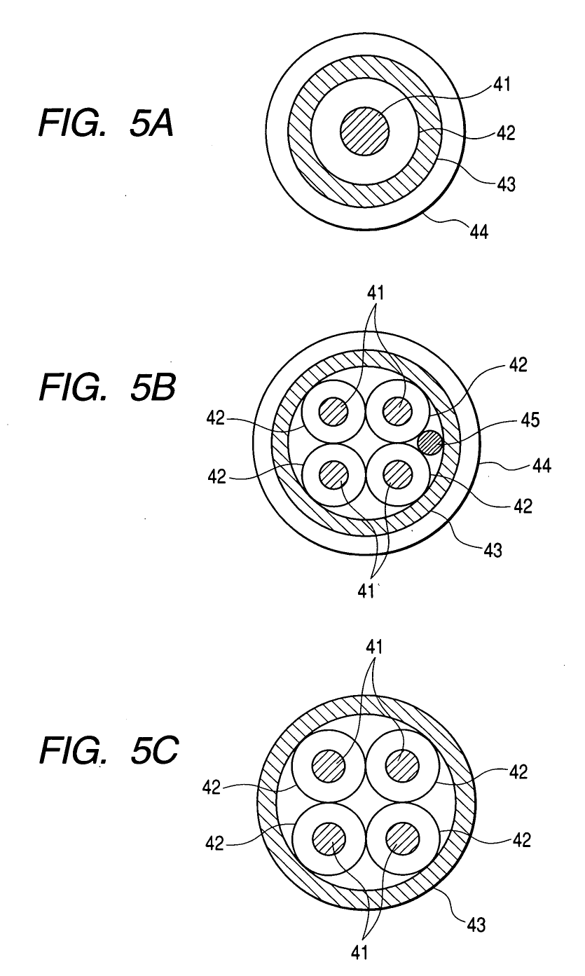

Furthermore, FIGS. 5A-5C show cross-sectional views showing various shielding arrangements. FIG. 5A shows a single core wire 41 surrounded by a sheathing layer 42 together with a shielding layer 43 covering the outside of the sheathing layer 42 and a vinyl sheath 44 provided as a protecting layer at the outermost side. FIG. 5B shows a plurality of core wires 41 each being surrounded by a sheathing layer 42 together with a shielding layer 43 collectively covering the outside of respective sheathing layers 42 and a vinyl sheath 44 provided as a protecting layer at the outermost side. In addition, a drain wire 45 is provided inside the shielding layer 43 so as to extend along this shield layer 43. FIG. 5C shows a plurality of core wires 41 each being surrounded by a sheathing layer 42 together with a shielding layer 43 collectively covering the outside of respective sheathing layers 42. In this case, the shielding layer 43 is directly fixed to the ground potential. The above-described arrangements are based on coaxial cable arrangement.

According to the above-described wiring structure, respective electric cables H2 and H3 are arranged in such a manner that each core wire 41 is surrounded by the shielding layer 43 and the shielding layer 43 is fixed to the ground potential. Hence, this arrangement effectively prevents the electric cables H2 and H3 from being adversely influenced by induction noise or capacity coupling noise generated from the heater cable H4 or by radio wave noises or other external noises. Accordingly, accurately detecting the element current of nA level is feasible.

According to the above-described arrangement of the electric cables H2 and H3, the voltage of approximately 1V is applied to the core wire 41 while the electric potential of the shielding layer 43 is fixed to the ground potential. The electric potential difference between the inside and outside of the sheathing layer 42 possibly causes a leak current flowing across the sheathing layer 42. Hence, to eliminate the influence given from the leak current flowing across the sheathing layer 42, a preferable volume resistivity ρ of the sheathing layer 42 is equal to or larger than 1.0×10¹² (Ω·cm).

More specifically, as shown in FIG. 8, when S (cm²) represents an average cross section of the material, L (cm) represents a measuring distance for the electric resistance, and R (Ω) represents an electric resistance value, the volume resistivity ρ (Ω·cm) of the material is expressed by the following equation.

ρ=(S/L)×R (1)

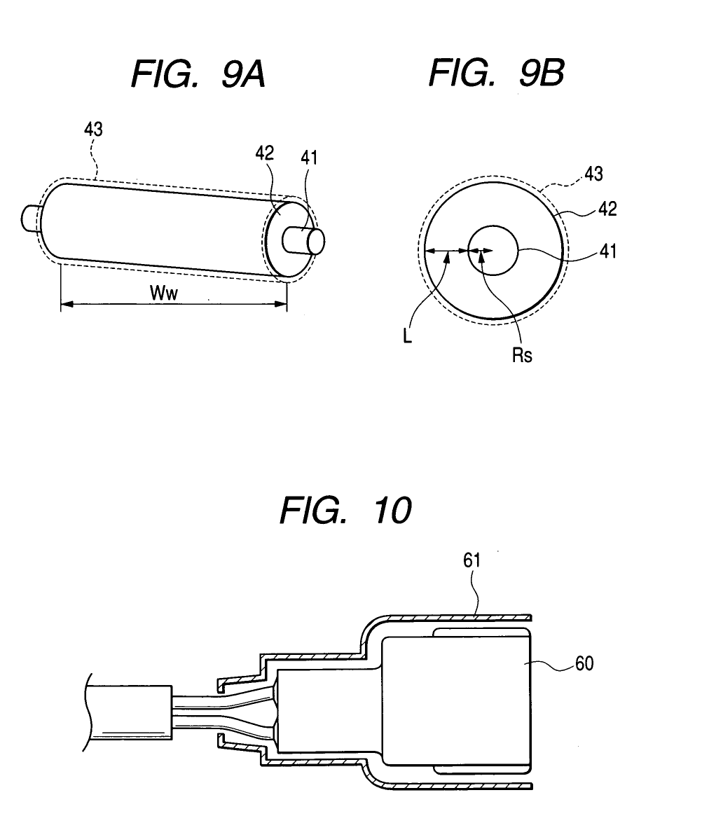

This relationship can be applied to the sheathing layer of the electric cable. FIGS. 9A and 9B show an electric cable having the single-core structure, in which the components identical with those disclosed in FIGS. 3 and 4 are denoted by the same reference numerals. FIG. 9A is a perspective view showing the appearance of the electric cable, while FIG. 9B is a front view showing a layered structure of the electric cable.

In FIGS. 9A and 9B, Rs represents a core wire diameter and Ww represents the length of the sheathing layer 42. The distance between the core wire 41 and the shielding layer 43, i.e. the thickness of sheathing layer 42, corresponds to the measuring distance L. In this case, the average cross section S can be expressed by using the equation S=π(2Rs+L)×Ww, and the following equation can be derived considering the above equation (1).

ρ=R×{π(2Rs+L)×Ww}/L (2)

The element current flowing in the monitor cell 120 or the sensor cell 130 is approximately 500 nA (0.5 μA). Assuming that an allowable leak current is 0.2% of the element current (1 nA), the resistance value R required for the sheathing layer 42 is equal to or larger than 1GΩ (R=1(V)/1(nA)≧1×10⁹Ω=1GΩ). Furthermore, assuming that the core wire diameter is Rs=0.05 cm and the measuring distance is L=0.05 cm from the dimensions of general wiring materials, and also assuming that the length of sheathing layer 42 is Ww=100 cm, the volume resistivity ρ≧0.94×10¹² (Ω·cm) is derived from the above-described equation (2). Therefore, satisfying the relationship ρ≧1.0×10¹² (Ω·cm) assures the required accuracy for measuring the element current.

In the case of using Teflon (registered trademark) as the sheathing layer 42, the volume resistivity according to catalog data or specifications sufficiently satisfy the relationship ρ≧10¹⁸ (Ω·cm). In other words, the Teflon-made sheathing layer 42 can sufficiently satisfy the above-described requirements. However, any other material having the properties capable of satisfying the volume resistivity ρ≧10¹² (Ω·cm) can be used for forming the sheathing layer. For example, when an AV line is used as a general automotive vehicle wire, the volume resistivity ρ according to the specifications is approximately in the level of 10¹⁰ to 10¹⁵ (Ω·cm). Accordingly, if management is carefully done to satisfy the requirement for the volume resistivity ρ≧10¹² (Ω·cm), the AV line will be used for the sheathing layer 42. In the case of using Teflon (registered trademark), no such troublesome management is required.

Although the sheathing layer length Ww is 100 cm and the core wire voltage is 1V according to the above-described calculation example, the resistance value R becomes small with increasing the sheathing layer length Ww and the leak current becomes large with increasing the core wire voltage. Therefore, using the Teflon-made wire satisfying the requirement with respect to the volume resistivity ρ≧10¹⁸ (Ω·cm) is effective in further eliminating the leak current.

Furthermore, with respect to the electric cables H2 and H3 used for measuring the weak element current, this embodiment executes the ground processing for fixing the shielding layer 43 to the ground potential separately from the ground processing for fixing the heater 151 to the ground potential, although not shown in the drawings. More specifically, the shielding layer 43 of respective electric cables H2 and H3 is connected to the ground terminal of the sensor control unit 10 and a negative terminal of the heater 151 is connected to the ground terminal of the engine or to the engine ECU 20. This arrangement can protect the ground potential of the shielding layer 43 from being adversely influenced by the fluctuation occurring in the ground potential of the heater 151 (i.e. the reference potential).

Regarding the connector portion constituting the wiring unit, it is possible to provide a shield outside the connector portion. For example, as shown in FIG. 10, a casing 61 serving as a shield can be provided to cover a connector portion 60. In this case, the connector portion 60 is a resin-made product and the casing 61 is made of a metallic or highly electrically-conductive material. The casing 61 is fixed to the ground potential. The casing 61 can be replaced with a conductive tape or the like wound around the connector portion 60. This arrangement can improve the noise durability of the connector portion 60. The detection accuracy for measuring the gas concentration (e.g. the NOx concentration according to this embodiment) can be further improved.

Furthermore, it is preferable to provide the element current connector used for connecting the weak element current cables H2 and H3 to the sensor control unit 10 separately from the heater connector used for connecting the heater cable H4 to the sensor control unit 10. This arrangement is effective in improving the noise durability of the element current connector as well as in improving the detection accuracy for measuring the gas concentration. It is also possible to provide a shield covering the outside the element current connector (like the casing 61 shown in FIG. 10). The noise durability can be further improved.

The above-described embodiment brings the following excellent effects.

Providing the shielding layer 43 surrounding the core wire 41 for the weak element current cables H2 and H3 is effective in eliminating the adverse influence given from the induction noise or the capacity coupling noise generated from the heater cable H4. Furthermore, the above-described embodiments bring sufficient noise durability even when various electric devices (i.e. noise sources) are equipped in an automotive vehicle. As a result, accurately detecting the element current is feasible. Furthermore, the detection accuracy for the gas concentration (NOx concentration in this embodiment) can be improved. To eliminate noises, there is a conventional case that the weak current cables must be kept far from the heater cable. However, this embodiment does not require such management.

The sheathing layer 42 is limited to the material having the volume resistivity equal to or larger than 1.0×10¹² (Ω·cm). For example, Teflon (registered trademark) is used for the sheathing layer 42. Thus, it becomes possible to surely prevent the element current from leaking via the sheathing layer 42. Therefore, the reliability for detection result of the element current can be further improved.

Furthermore, the external radio wave noises superposed on the electric cables H1 to H5 are surely absorbed by the feedthrough capacitors 35 immediately before these noises enter the sensor control circuit substrate 33. The sensor control circuit substrate 33 is provided in the first chamber A spaced from the wiring connecting substrate 34 (electric cables H1 to H5). Accordingly, the sensor control circuit substrate 33 is not adversely influenced by the external noises. Accurately detecting the element current is feasible. Furthermore, the detection accuracy for the gas concentration can be improved.

The partition plate 32 has the function of supporting the feedthrough capacitors 35 and the function of separating the inside space of the casing 30 into two chambers. There is no necessity of providing an additional dedicated partition wall. The arrangement is simple.

The present invention is not limited to the above-described embodiment, and accordingly can be modified in the following manner.

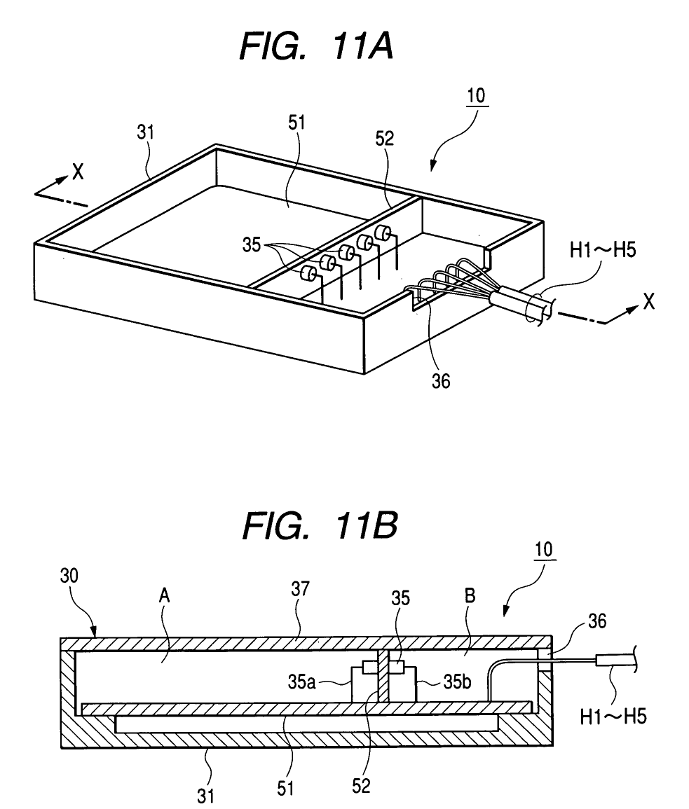

FIGS. 11A and 11B show a modified arrangement of the sensor control unit 10. The sensor control unit 10A shown in FIG. 11 is different from the sensor control unit 10 shown in FIG. 2 in that only one circuit substrate 51 is disposed and extends entirely in the casing body 31. A partition plate 52 stands vertically from the circuit substrate 51. Like the partition plate 32 shown in FIG. 2, the partition plate 52 has a function of supporting the feedthrough capacitors 35 and a function of separating the inside space (i.e. an upper space of circuit substrate 51) of the casing 30 into two chambers. In this case, a surface on which the electric cables H1 to H5 of the wiring unit are connected to the circuit substrate is identical with a surface from which the partition plate 52 stands. Furthermore, as shown in FIG. 11B, the circuit substrate 51 serves as the control circuit section at the left side of the partition plate 52 and serves as the connecting circuit section at the right side of the partition plate 52. Namely, as the inside space of the casing body 31 is separated into the control circuit section and the connecting circuit section by the partition plate 52, the control circuit section is not adversely influenced by the external noises.

According to the above-described embodiments, both the control circuit section (i.e. sensor control circuit substance) and the connecting circuit section (i.e. wiring connecting substrate) are accommodated in the casing 30. It is however possible to separately provide the connecting circuit section outside the casing. In short, the control circuit section (i.e. sensor control circuit substrate) is accommodated in a closed space of the casing and the feedthrough capacitors are disposed on a wall portion of this casing, and further the connecting circuit section (i.e. wiring connecting substrate) is disposed outside the above closed space. The connecting circuit section and the control circuit section are electrically connected via the feedthrough capacitors. This arrangement surely prevents the control circuit section from being adversely influenced by the external noises. Accurately detecting the element current is feasible.

According to the above-described embodiments, the current level of the pump cell current is larger than the monitor cell current or the sensor cell current. Hence, in addition to the heater cable H4, no shield is provided for the electric cable H1 that measures the pump cell current. However, it is possible to apply the shield to the electric cable H1.

The above-described embodiments adopt the arrangement effective in reducing the noises influencing the electric cables (e.g. provision of shield etc) and also adopt the arrangement effective in reducing the noises influencing the casing of the sensor control unit (e.g. provision of feedthrough capacitors etc). However, it is possible to adopt only one of these two anti-noise arrangements.

Besides the gas concentration sensor (NOx sensor) capable of detecting the NOx concentration, the present invention can be applied to a HC sensor, a CO sensor, or any other type of gas concentration sensor capable of detecting the HC concentration, the CO concentration, or any other specific gas concentration. In this case, the pump cell (i.e. first cell) discharges excessive oxygen from the sensing objective gas and then the sensor cell (i.e. second cell) decomposes HC or CO from the residual gas to detect the HC concentration or the CO concentration.

Furthermore, the present invention can be applied to any gas concentration detecting apparatuses other than automotive vehicles. Any gas other than the exhaust gas can be used as a sensing objective gas.

What is claimed is:

1. A gas concentration detecting apparatus comprising:
a gas concentration sensor equipped with a sensor element having a solid electrolytic substrate for detecting a gas concentration of a specific component contained in a sensing objective gas and a heater for heating said sensor element to a predetermined activated condition,
a sensor control unit for measuring a weak element current flowing in said sensor element in accordance with the concentration of said specific component and for intermittently supplying electric power to said heater, and
a wiring unit for providing electric connection between said gas concentration sensor and said sensor control unit, wherein
said wiring unit comprises an element current cable used for measuring the element current and a heater cable used for supplying electric power to said heater, and
a shielding layer fixed to a ground potential is provided outside a core wire of said element current cable through which said element current flows.

2. The gas concentration detecting apparatus in accordance with claim 1, wherein said element current cable comprises a sheathing layer surrounding said core wire and said shielding layer covers the outside of said sheathing layer.

3. The gas concentration detecting apparatus in accordance with claim 2, wherein a volume resistivity of said sheathing layer is equal to or larger than 1.0×10¹² (Ω·cm).

4. The gas concentration detecting apparatus in accordance with claim 2, wherein said sheathing layer is made of Teflon (registered trademark).

5. The gas concentration detecting apparatus in accordance with claim 1, wherein said element current cable includes a plurality of core wires that are collectively covered with said shielding layer.

6. The gas concentration detecting apparatus in accordance with claim 1, wherein said element current cable includes at least one core wire covered with a sheathing layer, and said shielding layer is located outside said sheathing layer, and further a protecting layer is provided outside said shielding layer.

7. The gas concentration detecting apparatus in accordance with claim 1, wherein said element current cable includes a plurality of core wires each being covered with a sheathing layer, and said shielding layer is located outside said plurality of core wires, and further a protecting layer is provided outside said shielding layer.

8. The gas concentration detecting apparatus in accordance with claim 1, wherein the ground processing for fixing said shielding layer of said element current cable to the ground potential is carried out separately from the ground processing for fixing said heater to the ground potential.

9. The gas concentration detecting apparatus in accordance with claim 1, wherein said wiring unit is connected to said sensor control unit via a connector member, and a shield surrounds the outer surface of said connector member.

10. The gas concentration detecting apparatus in accordance with claim 1, wherein an element current connector used for connecting said element current cable to said sensor control unit is provided separately from a heater connector used for connecting said heater cable to said sensor control unit.

11. The gas concentration detecting apparatus in accordance with claim 1, wherein a control circuit section included in said sensor control unit is accommodated in a closed space of a casing that is made of an electrically-conductive material and fixed to the ground potential, and a feedthrough capacitor is disposed on a wall portion of said casing, and further a connecting circuit section electrically connected to said wiring unit is disposed outside said closed space, and said connecting circuit section and said control circuit section are electrically connected via said feedthrough capacitor.

12. The gas concentration detecting apparatus in accordance with claim 1, wherein
a casing made of an electrically-conductive material and fixed to the ground potential is divided into two chambers with a partition plate made of an electrically-conductive material and fixed to the ground potential,
a feedthrough capacitor is disposed on said partition plate,
a control circuit section included in said sensor control unit and a connecting circuit section electrically connected to said wiring unit are respectively accommodated into said two chambers, and
said control circuit section and said connecting circuit section are electrically connected via said feedthrough capacitor.

13. A gas concentration detecting apparatus comprising:
a gas concentration sensor equipped with a sensor element having a solid electrolytic substrate for detecting a gas concentration of a specific component contained in a sensing objective gas and a heater for heating said sensor element to a predetermined activated condition,
a sensor control unit for measuring a weak element current flowing in said sensor element in accordance with the concentration of said specific component and for intermittently supplying electric power to said heater, and
a wiring unit for providing electric connection between said gas concentration sensor and said sensor control unit, wherein
a control circuit section included in said sensor control unit is accommodated in a closed space of a casing that is made of an electrically-conductive material and fixed to the ground potential,
a feedthrough capacitor is disposed on a wall portion of said casing,
a connecting circuit section electrically connected to said wiring unit is disposed outside said closed space, and
said connecting circuit section and said control circuit section are electrically connected via said feedthrough capacitor.

14. A gas concentration detecting apparatus comprising:
a gas concentration sensor equipped with a sensor element having a solid electrolytic substrate for detecting a gas concentration of a specific component contained in a sensing objective gas and a heater for heating said sensor element to a predetermined activated condition,
a sensor control unit for measuring a weak element current flowing in said sensor element in accordance with the concentration of said specific component and for intermittently supplying electric power to said heater, and
a wiring unit for providing electric connection between said gas concentration sensor and said sensor control unit, wherein
a casing made of an electrically-conductive material and fixed to a ground potential is divided into two chambers with a partition plate made of an electrically-conductive material and fixed to the ground potential,
a feedthrough capacitor is disposed on said partition plate,
a control circuit section included in said sensor control unit and a connecting circuit section electrically connected to said wiring unit are respectively accommodated into said two chambers, and
said control circuit section and said connecting circuit section are electrically connected via said feedthrough capacitor.

15. The gas concentration detecting apparatus in accordance with claim 12, wherein said control circuit section and said connecting circuit section are provided on the same circuit substrate, and said partition plate is provided on said circuit substrate so that said partition plate extends vertically between said control circuit section and said connecting circuit section.

16. The gas concentration detecting apparatus in accordance with claim 14, wherein said control circuit section and said connecting circuit section are provided on the same circuit substrate, and said partition plate is provided on said circuit substrate so that said partition plate extends vertically between said control circuit section and said connecting circuit section.

17. The gas concentration detecting apparatus in accordance with claim 11, wherein a capacitance of said feedthrough capacitor is equal to or larger than 1000 pF.

18. The gas concentration detecting apparatus in accordance with claim 13, wherein a capacitance of said feedthrough capacitor is equal to or larger than 1000 pF.

19. The gas concentration detecting apparatus in accordance with claim 14, wherein a capacitance of said feedthrough capacitor is equal to or larger than 1000 pF.

20. The gas concentration detecting apparatus in accordance with claim 1, wherein said sensor element comprises
a first cell for discharging or pumping oxygen out of or into the sensing objective gas in a chamber,
a second cell for decomposing the specific component contained in the gas after said gas passed said first cell and detecting a gas concentration of said specific component based on an oxygen ion amount moving during decomposition of said specific component, and
said sensor control unit measures a weak current flowing at least in said second cell.

21. The gas concentration detecting apparatus in accordance with claim 14, wherein said sensor element comprises
a first cell for discharging or pumping oxygen out of or into the sensing objective gas in a chamber,
a second cell for decomposing the specific component contained in the gas after said gas passed said first cell and detecting a gas concentration of said specific component based on an oxygen ion amount moving during decomposition of said specific component, and
said sensor control unit measures a weak current flowing at least in said second cell.

22. The gas concentration detecting apparatus in accordance with claim 14, wherein said sensor element comprises
a first cell for discharging or pumping oxygen out of or into the sensing objective gas in a chamber,
a second cell for decomposing the specific component contained in the gas after said gas passed said first cell and detecting a gas concentration of said specific component based on an oxygen ion amount moving during decomposition of said specific component, and
said sensor control unit measures a weak current flowing at least in said second cell.
